(19) United States
(12) Patent Application Publication
(10) Pub. No.: US 2020/0090166 A1
(43) Pub. Date: Mar. 19, 2020

(54) SYSTEM AND METHOD FOR CARDLESS TRANSACTIONS

(71) Applicant: JPMorgan Chase Bank, N.A., New York, NY (US)

(72) Inventor: William H. TONINI, Stamford, CT (US)

(21) Appl. No.: 14/683,364

(22) Filed: Apr. 10, 2015

(51) Int. Cl. G06Q 20/38; G06Q 20/18

(52) U.S. Cl. CPC G06Q 20/385; G06Q 20/18

(57) ABSTRACT

Exemplary embodiments provide methods and systems for conducting a cardless transaction with a financial transaction machine or a POS device. A customer requests a cardless withdrawal or cardless deposit from one of her/his accounts using the mobile application. Alternatively, a cardless transaction may be selected at a merchant. The customer receives a one-time use code in the mobile application, that is valid for a length of time. The customer proceeds to an appropriate financial transaction machine or a merchant's POS device and selects a designated menu option from an interface to conduct the desired cardless transaction. The customer is requested to enter the code to conduct the transaction. Upon successful validation of the code, the requested transaction is conducted, the code is marked as used by the system, the account is updated, and a notification is sent to the mobile application.

### FIELD OF THE INVENTION

The present disclosure generally relates to cardless transactions with financial transaction machines and point of sale systems. Specifically, the cardless transactions may include withdrawals, deposits, and purchases.

### BACKGROUND

Financial institution customers use financial transaction machines, such as express banking kiosks (“EBKs”) or automated teller machines (“ATMs”), to perform certain financial institution transactions. Financial transaction machines typically require debit cards, credit cards, or designated access card (such as an ATM card) to authenticate a customer to allow access to the financial transaction machine. For one reason or another, a customer may not have a required form of authentication, such as a debit card, to use to authenticate him/herself at the machine.

Therefore, if a financial institution customer leaves their card at home (e.g., forgetting their wallet), then the customer is unable to access a financial transaction machine to conduct a transaction. Conventional systems and methods do not enable a customer who is unable to authenticate him/herself at the financial transaction machine to use the machine to perform a desired transaction.

Similarly, a customer may desire to conduct a transaction with a merchant but lack a transaction card since the customer has forgotten their wallet.

These and other deficiencies exist.

### SUMMARY OF THE INVENTION

An exemplary embodiment includes a system having a financial transaction machine, including at least one non-transitory storage medium with computer readable instructions to conduct a cardless transaction, comprising at least one of a cardless withdrawal and a cardless deposit, such that the instructions cause a display of an option to conduct the cardless transaction, cause a request for entry of a code to be displayed upon selection of the option, cause a validation of an entered code to be performed, and cause the cardless transaction to occur upon validation of the entered code; at least one display, the at least one display being configured to display the option to conduct the cardless transaction from the financial transaction machine and the at least one display being further configured to display a request for entry to the code in response to a selection of the option to conduct the cardless transaction; at least one input device, the at least one input device being configured to receive inputs from a customer in response to the selection of the option to conduct the cardless transaction, the inputs comprising at least entry of the code; and at least one processor, responsive to the instructions, configured to cause validation of the received code and further configured to cause the cardless transaction upon successful validation of the code, the at least one processor being communicatively coupled to a network; and a remotely located server, communicatively coupled to the network, that is configured to receive a validation request of the code from the at least one processor and to conduct a validation of the received code, and is further configured to transmit results of the validation to the at least one processor.

Another exemplary embodiment includes a computer-implemented method having the steps of: receiving a request for a cardless transaction from a mobile banking application; and providing, by the computer processor, a code to the mobile banking application in response to the request.

Another exemplary embodiment includes a computer-implemented method having the steps of: receiving, at a financial transaction machine, a selection of a menu option to conduct a cardless transaction, comprising one of a cardless withdrawal and a cardless deposit, wherein the cardless transaction was previously requested through a mobile banking application; requesting entry of a code; receiving entry of the code; verifying the code; and performing, upon successful verification, the cardless transaction.

Another exemplary embodiment includes a computer implemented method having the steps of: receiving at a point of sale device, a selection to conduct a cardless transaction, wherein the cardless transaction was previously requested through a mobile banking application; requesting entry of a code; receiving entry of the code; verifying the code; and performing, upon successful verification, the cardless transaction.

In various exemplary embodiments, the preceding methods may be performed using a system with at least one processor and a memory comprising computer-readable instructions which when executed by the processor cause the processor to perform the method steps.

These and other embodiments and advantages will become apparent from the following detailed description, taken in conjunction with the accompanying drawings, illustrating by way of example the principles of the various exemplary embodiments.

### BRIEF DESCRIPTION OF THE DRAWINGS

FIG. 1 is a diagram of a system for cardless withdrawal at a financial transaction machine in accordance with an exemplary embodiment.

FIG. 2 is a flow chart of a method for conducting a cardless withdrawal at a financial transaction machine in accordance with an exemplary embodiment.

FIG. 3 is a flow chart of a method for conducting a cardless withdrawal at a financial transaction machine in accordance with an exemplary embodiment.

FIG. 4 is a flow chart of a method for conducting a cardless withdrawal in accordance with an exemplary embodiment.

FIG. 5 is an interface for selection of a cardless withdrawal at a financial transaction machine in accordance with an exemplary embodiment.

FIG. 6 is an interface for entry of a cell phone number during a cardless withdrawal at a financial transaction machine in accordance with an exemplary embodiment.

FIG. 7 is an interface for entry of a code during a cardless withdrawal at a financial transaction machine in accordance with an exemplary embodiment.

FIG. 8 is an interface for entry of a PIN during a cardless withdrawal at a financial transaction machine in accordance with an exemplary embodiment.

FIG. 9 is an interface for selection of a withdrawal amount during a cardless withdrawal at a financial transaction machine in accordance with an exemplary embodiment.

FIG. 10 is a flow chart of a method for conducting a cardless deposit at a financial transaction machine in accordance with an exemplary embodiment.

FIG. 11 is a flow chart of a method for conducting a cardless deposit at a financial transaction machine in accordance with an exemplary embodiment.

FIG. 12 is a flow chart of a method for conducting a cardless deposit a in accordance with an exemplary embodiment.

FIG. 13 is an interface for selection of a cardless deposit at a financial transaction machine in accordance with an exemplary embodiment.

FIG. 14 is an interface for selection of a cardless transaction at a financial transaction machine in accordance with an exemplary embodiment.

FIG. 15 is an interface for entry of a deposit amount during cardless transaction at a financial transaction machine in accordance with an exemplary embodiment.

FIGS. 16 is a flow chart of a method for conducting a cardless transaction at a point of sale device in accordance with an exemplary embodiment.

FIG. 17 is a flow chart of a method for conducting a cardless transaction at a point of sale device in accordance with an exemplary embodiment.

FIG. 18 is a flow chart of a method for conducting a cardless transaction in accordance with an exemplary embodiment.

### DETAILED DESCRIPTION OF THE PREFERRED EMBODIMENTS

It will be readily understood by those persons skilled in the art that the embodiments described herein are capable of broad utility and application. Accordingly, while the invention is described herein in detail in relation to the exemplary embodiments, it is to be understood that this disclosure is illustrative and exemplary of embodiments of the invention and is made to provide an enabling disclosure. Accordingly, the disclosure is not intended to be construed to limit the embodiments or otherwise to exclude any other such embodiments, adaptations, variations, modifications and equivalent arrangements. While the various exemplary embodiments of the present invention are described in the context of financial transactions at financial transaction machines, the methods and systems described herein may be applied to other related services involving interaction with similar devices.

The following descriptions provide different configurations and features according to exemplary embodiments. These configurations and features may relate to providing financial services through financial services machines. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any combination as is within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

“Financial transaction machine” or “financial transaction device” as used herein, may include machines, devices, kiosks, and stations, each of which may be fixed or portable, for performing financial transactions with a financial institution. For example, financial transaction machines may include, but are not limited to, express banking kiosks (“EBKs”), automated teller machines (“ATMs”), personal teller machines (“PTMs”), financial self-service devices, financial services kiosks, financial transaction devices, portable electronic devices, money machines, cash machines, bank machines, and bancomats. Financial transaction machines may be located within or near a branch of a financial institution, a retailer, a merchant, or other public location. It should be appreciated that, while various exemplary embodiments are described herein in terms of an EBK, these descriptions are meant to be non-limiting and equally applicable to other forms of financial transaction machines. The financial transaction machine may be operated by a financial institution.

The term “financial institution,” as used herein, may include institutions that provide financial services to their members or customers. Financial institutions may include, but are not limited to banks, credit unions, trust companies, mortgage loan companies, insurance companies, investment banks, underwriters, and brokerage firms. The use of the term “bank” and “financial institution” herein is meant to be exemplary and non-limiting.

The term “customer,” as used herein, may refer to an individual who holds at least one account with the financial institution.

The customer may have a physical form device used for access to a financial transaction machine that serves as a form of authentication. For example, the customer may have a card, such as a debit card, a credit card, or an EBK/ATM card, that is linked to a corresponding personal identification number (PIN). This card may be used to access the financial transaction machine to conduct a transaction. It should be appreciated that the use of the terms “debit card,” “ATM card,” and “credit card” are meant to be exemplary and non-limiting examples. Customers may swipe, dip, or otherwise present the card at the financial transaction machine and then enter the corresponding PIN to authenticate themselves, i.e., to confirm that they are the owners of the accounts associated with the presented card. This authentication may be required to conduct a transaction with the financial transaction machine. For one reason or another, a customer may not have the physical card (e.g., debit card or EBK/ATM card) with them when visiting a financial transaction machine but still may desire and/or need to conduct a transaction with the financial transaction machine. The customer may not be near or otherwise able to access (e.g., it may be outside of regular business hours) a branch office of the financial institution. In some situations, the customer may lack any physical identification and the customer may even lack their wallet. The customer may have a mobile device with them. For example, the customer may have a smartphone in their possession.

Exemplary embodiments provide methods and systems for conducting financial transactions with a financial transaction machine. A mobile application, such as one provided by a financial institution with which the customer has an account, is used. The mobile application may be installed on a portable electronic device, such as a tablet or smartphone. According to an exemplary embodiment, the customer requests a withdrawal from one of her/his accounts or a deposit into one of his/her accounts using the mobile application.

The customer receives a one-time use code in the mobile application. For example, the code may be numeric and of a particular length. In various exemplary embodiments, the code may be 8-10 digits; however, longer and shorter codes are possible. The code may be randomly generated for each requested transaction. The code is valid for a certain amount of time to be used in any financial transaction machine connected directly with the financial institution, or indirectly using a payment network, processor, or gateway. In various exemplary embodiments, a specific financial transaction machine may be designated by the customer for the withdrawal or deposit. After the period of time expires, the code expires and is no longer valid. Once the code is used, it is also no longer valid for any transactions.

The customer proceeds to an appropriate financial transaction machine and selects a designated menu option from the interface of the financial transaction machine to conduct the transaction. For example, the designated menu option may be labeled “cardless cash,” “cardless withdraw,” “cardless withdrawal,” “cardless operation,” or “mobile cash.” Other appropriate menu options may be available such as “cardless deposit.” The customer is requested to enter the code to conduct the transaction. In various exemplary embodiments, additional information may be required to be entered as further validation of the customer's identify, such as a cell phone number associated with the account and the customer's PIN. This information is presumably something only the customer knows and entry is a way to verify an authorized person is conducting the transaction. The customer may be asked to input an amount for withdrawal or an amount for deposit. Upon successful validation of the information provided, the requested cash is dispensed, the code is marked as used by the system, the account is updated, and a notification is sent to the mobile application.

In the event the transaction is either cancelled by the customer during the confirmation process, or credentials are not correct (i.e., the code and other entered information cannot be validated), after a certain number of attempts, the code is invalidated. If the customer still desires a transaction, the customer must request a new code through the mobile application.

In various exemplary embodiments, the code can be in the form of a 16-digit number that can be used for a cardless transaction for a purchase at a point of sale (POS) device at a merchant. The customer may therefore request a transaction through the mobile application.

The may be required to specify a transaction amount as well as a merchant at which the transaction is to be conducted.

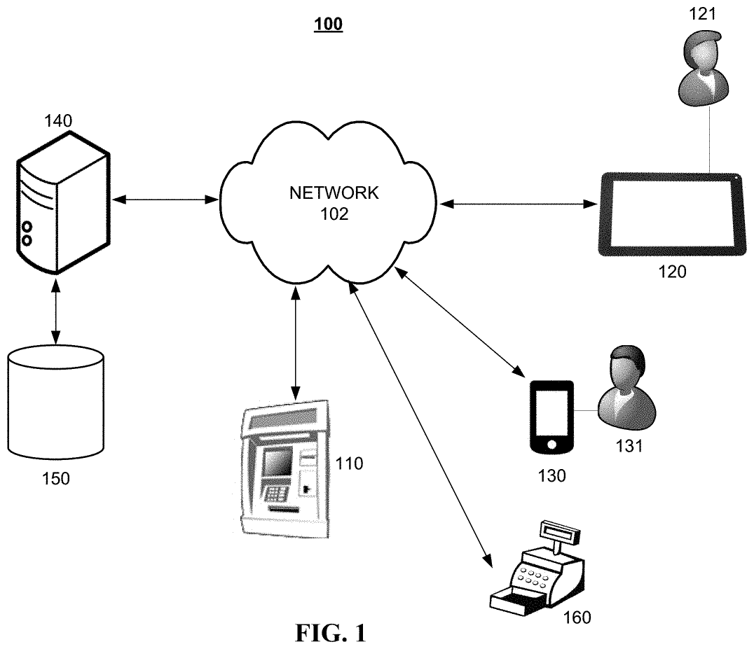

Referring to FIG. 1, a schematic diagram of a system 100 is shown, according to an exemplary embodiment. As illustrated, network 102 may be communicatively coupled with one or more data devices including, for example, financial transaction machine 110, tablet computing device 120, smart phone device 130, server 140, database 150, and point of sale device 160. The devices 120 and 130 may be associated with customers 121 and 131, respectively. The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or ore network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

The network 102 may be a wireless network, a wired network or any combination of wireless network and wired network. For example, the network 102 may include one or more of an Internet network, a satellite network, a wide area network (WAN), a local area network (“LAN”), an ad hoc network, a Global System for Mobile Communication (“GSM”), a Personal Communication Service (PCS), a Personal Area Network (PAN), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, the network 102 may support an Internet network, a wireless communication network, a cellular network, Bluetooth, or the like, or any combination thereof. The network 102 may further include one, or any number of the exemplary types of networks mentioned above operating as a stand-alone network or in cooperation with each other. The network 102 may utilize one or more protocols of one or more network elements to which it is communicatively coupled. The network 102 may translate to or from other protocols to one or more protocols of network devices. Although the network 102 is depicted as one network for simplicity, it should be appreciated that according to one or more embodiments, the network 102 may comprise a plurality of interconnected networks, such as, for example, a service provider network, the Internet, a cellular network, corporate networks, or even home networks, or any of the types of networks mentioned above.

Data may be transmitted and received via network 102 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 1 shows a single financial transaction machine 110, tablet device 120, smartphone device 130, server 140, and database 150, it should be appreciated that there may be several of such devices to carry out the various exemplary embodiments. For example, the financial transaction device 110 may represent several EBKs, any one of which may be used to practice the various exemplary embodiments. Again, the use of EBKs is meant to be non-limiting and, may include, but are not limited to, automated teller machines (“ATMs”), personal teller machines (“PTMs”), financial self-service devices, financial services kiosks, financial transaction devices, portable electronic devices, money machines, cash machines, bank machines, and bancomats, for example. The financial transaction device 110 may be associated with and/or operated by a financial institution. The financial transaction machine may be connected directly with the financial institution, or indirectly using a payment network, processor, or gateway.

The financial transaction machine 110 may comprise, for example, a display, which may be touch-sensitive or otherwise; an alpha-numeric and/or QWERTY keyboard, either physical or virtual, for receiving input; a pointing device, such as a trackball, track wheel, or mouse, for example; a scanning camera to scan items displayed or presented by customers 121 and/or 131; a cash dispenser; a check and/or cash receiver; a printer, such as for printing receipts, for example; a biometric scanner, such as a fingerprint or retinal scanner; and communication chipsets for communicating with other devices, such as server 140, tablet device 120, and/or smartphone device 130, directly or via network 102, for example.

The tablet device 120 may be associated with a customer 121. The customer 121 may have one or more accounts with the financial institution that operates the financial transaction machine 110. The tablet device 120 may alternatively be a laptop computer, a personal digital assistant, a smartphone, a smartwatch, smart glasses, or other computing devices capable of sending or receiving network signals. The tablet device 120 may have an application installed that is associated with the financial institution.

The smartphone device 130 may be associated with a customer 131. The customer 131 may have one or more accounts with the financial institution that operates the financial transaction machine 110. The tablet device 130 may alternatively be a laptop computer, a personal digital assistant, a tablet device, a smartwatch, smart glasses, or other computing devices capable of sending or receiving network signals. The tablet device 130 may have an application installed that is associated with the financial institution.

It should be appreciated that while two customers, 121 and 131, are depicted in FIG. 1, in various exemplary embodiments, the system 100 may have a single customer, such as customer 121 or 131, or, in various exemplary embodiments, the system 100 may have a plurality of customers, beyond the two customers depicted. Each customer may have an associated portable electronic device, such as, for example, a tablet computing device and/or a smartphone. Each customer may interact with the system 100 in the manner described herein.

The server 140 may perform operations associated with processing information and data associated with the financial transaction device 110, the tablet device 120, and/or the smartphone device 130. The server 140 may comprise one or more servers and/or computers, each having one or more computer processors associated therewith. In various exemplary embodiments, the server 140 may be a specific computing device to support exemplary embodiments as described herein.

The server 140 may be communicatively coupled with the database 150. The database 150 may contain data and information used by the system 100. For example, the database 150 may store account data for customers 121 and 131, as well as customer profile data. The database 150 may also contain additional information related to the operation and administration of the system 100. The database 150 may include any suitable data structure to maintain the information and allow access and retrieval of the information. For example, database 150 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art o store and organize data as described herein.

The database 150 may be any suitable storage device or devices. The storage may be local, remote, or a combination thereof with respect to the database 150. The database 150 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (MFS). The database 150 may have back-up capability built-in. Communications with the database 150 may be over a network, such as network 102, or communications may involve a direct connection between the database 150 and the server 140, as depicted in FIG. 1.

The point of sale device 160 may be associated with a merchant. The merchant may have a relationship with the financial institution such that the point of sale device 160 may be communicatively coupled, through the network 102, with the server 140 and the database 150. In various exemplary embodiments, the point of sale device 160 may be a server associated with an e-commerce website through with customer's conduct on-line transactions. In various exemplary embodiments, the point of sale device 160 may be a physical device located at a merchant's location.

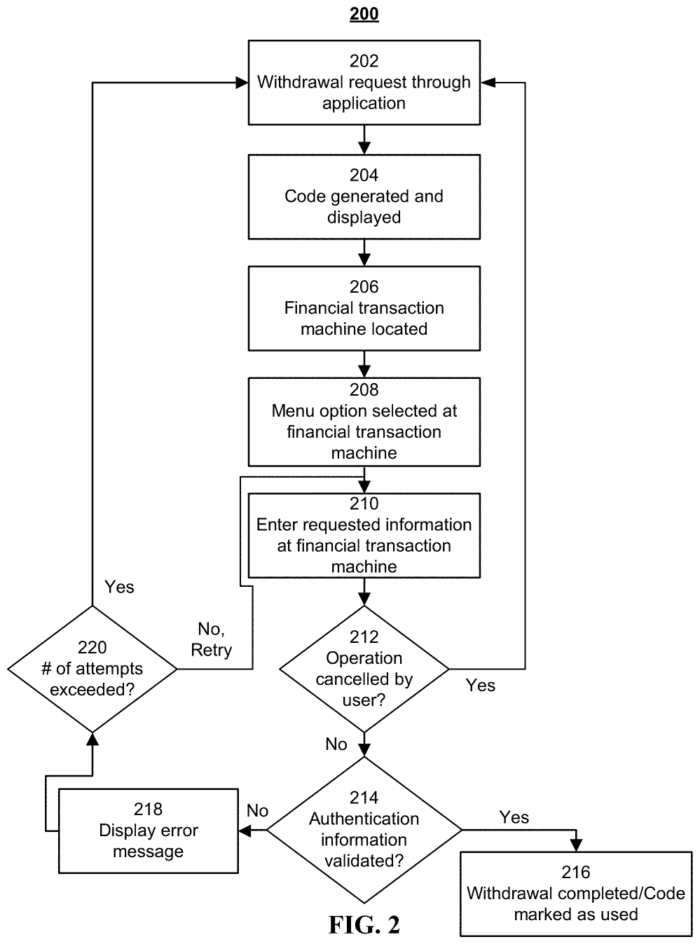

Referring to FIG. 2, an exemplary method 200 of conducting a cardless withdrawal is depicted. Exemplary method 200 may begin at block 202.

At block 202, a customer requests a withdrawal from one of her/his accounts using a mobile application. An account may be selected. The mobile application may be one provided by a financial institution with which the customer has one or more accounts. The mobile application may be installed on a portable electronic device. For example, the portable electronic device may be a tablet computing device or smartphone. The mobile application may have an option supporting the method 200 described herein. For example, the mobile application may have a “cardless cash,” “cardless withdraw,” “cardless withdrawal,” “cardless operation,” or “mobile cash” option.

These options may require additional security and/or authentication actions by the customer. The mobile application may require the customer to enter a username and/or password to access the option for authentication purposes. In various exemplary embodiments, this username and/or password may be in addition to a log in required to access the mobile application itself. In various exemplary embodiments, an access code may be required to be entered to access the option. This access code may be separate from the customer's password and the access code may be preconfigured by the customer through a website. The access code may be assigned by the financial institution.

The customer, as part of the transaction request, may be requested to enter an amount for withdrawal. In various exemplary embodiments, there may be amount limits for withdrawals associated with each of the customer's accounts. The amount limits may be predetermined by the financial institution. Amount limits, below those predetermined by the financial institution, may be configured by the customer via the mobile application or through the financial institution's website. The customer may configure withdrawal amount limits for each account for use with the method 200 described herein. In various exemplary embodiments, the use of the cardless withdrawal option may be limited. For example, the cardless withdrawal option may be limited to being used a predetermined number of times per month. This may be determined by the financial institution. In various exemplary embodiments, the customer may be able to limit the usage of the option. For example, the customer can configure a limit on the usage of the option. In various exemplary embodiments, the customer may not be required to specify an amount for withdrawal in the mobile application.

As part of the request, the mobile application may communicate with the financial institution. For example, the mobile application may communicate over a network, such as the network 102, with a server, such as the server 140. The communication may be necessary to transmit the details of the request input to the mobile application the financial institution. In various exemplary embodiments, the financial institution may process the request and may send a confirmation or acknowledge signal to the mobile application over the network.

At block 204, a code is generated and displayed through the mobile application. The code may be of any length or composition. For example, the code may be numeric and 8-10 digits in length. In various exemplary embodiments, the code may be alpha-numeric. The code may have checksums embedded on it, combining attributes such as account number, timestamp, and information.

The financial institution may generate the code in response to the received withdrawal request and transmit the code to the mobile application over the network. In various exemplary embodiments, the code may be locally generated by the mobile application. In these embodiments, where the code is locally generated, the mobile application may transmit the code to the financial institution. The financial institution may store the code and the withdrawal request associated therewith for future use with method described herein. In various exemplary embodiments, the financial institution may transmit the code and the withdrawal request to its network of financial transaction machines. In various exemplary embodiments, if a specific financial transaction machine or a set of financial transaction machines is indicated, as described below, the code and withdrawal request may be transmitted to those particular financial transaction machines.

The exchange of data between the mobile application and the financial institution may be secure (such as the withdrawal request and the code exchange). For example, the exchange of data may be encrypted. The mobile application may use the capabilities of the portable electronic device, on which it is installed, for communications with the network (e.g., transmitted and receiving data).

The code may be a one-time use code. The code may be valid for a certain amount of time. For example, the code may be valid for period of hours or may be valid for a day. Other time periods are possible. In various exemplary embodiments, the customer may select a time period for validity. The time period may be predetermined by the customer as part of the customer's preferences for the mobile application. The time period may be configured during each transaction request.

After the period of time expires, the code expires and is no longer valid. In various exemplary embodiments, the code may be used in any financial transaction machine associated with the financial institution or a financial transaction machine that directly or indirectly connects to the financial institution using a payment network, processor, or gateway. In various exemplary embodiments, a specific financial transaction machine may be designated by the customer for the withdrawal. For example, the mobile application may prompt the customer to select a specific financial transaction machine at which to conduct the transaction. A map-based interface may be used to allow the customer to locate a preferred location. The customer may be able to select a particular geographic area instead of a particular location. In various exemplary embodiments, a drop-down listing or other interface may be used to present the customer with locations for selection. In various exemplary embodiments, the customer may be given the option of selecting a particular financial transaction machine, a particular area, or having the code be valid at any financial transaction machine.

The code may be accessible through the mobile application for the duration of its validity to allow the customer access to it.

At block 206, an appropriate financial transaction machine is located.

At block 208, a designated menu option is selected from the interface of the financial transaction machine to conduct the transaction. For example, the designated menu option may be labeled “cardless cash,” “cardless withdraw,” “cardless withdrawal,” “cardless operation,” or “mobile cash.” The option may be selected from a touch screen, a designated function key/button, or using another appropriate interface. The financial transaction machine may then prompt the customer to enter authentication information to conduct the transaction. The authentication information requested may include the code received by the customer and any other information required to perform the desired operation.

At block 210, the requested information is entered. For example, the customer may enter the code. In various exemplary embodiments, additional authentication information may be required to be entered as further validation of the customer's identify, such as a cell phone number associated with the account, and the customer's PIN. This information is presumably something only the customer knows. In various exemplary embodiments, the information may be requested in different orders. For example, the code may be requested prior to other information. The cell phone number may be requested prior to the code and then the PIN requested after the code. Other orders are possible.

In various exemplary embodiments, the customer may be requested to enter an amount for withdrawal at the financial transaction machine. As described above, the customer may not specify an amount at the time of the request. The customer may specify an amount at the financial transaction machine, either before or after entry of any requested authentication information. In various exemplary embodiments, a selection of preset amounts may be presented to the customer. For example, preset amounts in various increments may be displayed for customer selection, such as amounts from $20 to $100, depending on the amount and types of currency bills available at the financial transaction machine. In various exemplary embodiments, the customer may alter the amount for withdrawal previously specified in the mobile application. The customer may be presented with the preselected amount for confirmation following entry of the authentication information.

At block 212, the withdrawal may be cancelled. The customer may be presented with a cancellation option at the financial transaction machine. The cancellation option may be available at various points in the method. If the withdrawal is not cancelled, then the method continues to block 214. In various exemplary embodiments, once the transaction is cancelled, the code is invalidated such that it cannot be used again for the transaction.

In various exemplary embodiments, the customer may have the option of cancelling the transaction through the mobile application. This cancellation causes the code to be invalidated.

If the customer desires another transaction, the method is begun again at block 202.

At block 214, the authentication information is validated. The financial transaction machine may transmit the received authentication information over a network. For example, the network 102 may be used. The transmitted information may be remotely processed and validated by the financial institution. For example, the server 140 may process and validate the information. The results of the validation may be transmitted back to the Imam al transaction machine over the network. In various exemplary embodiments, the data transmitted between the financial transaction machine and the financial institution over the network may be secure. For example, the data may be encrypted.

In various exemplary embodiments, the financial transaction machine may have previously received the code and withdrawal request over the network. The entered authentication information may be locally processed and validated by the financial transaction machine. In various exemplary embodiments, a combination of local and remote processing and validation may occur. For example, the code may be validated locally (if previously received) and the authentication information may be remotely validated.

At block 216, upon successful authentication, the requested cash is dispensed, the code is marked as used by the system, the account is updated, and a notification is sent to the mobile application. The notification may be an indication of a successful completion of the withdrawal.

At block 218, upon unsuccessful authentication, an error message displayed. A notification may be sent to the mobile application. The notification may be an indication of an unsuccessful withdrawal request. The customer may be allowed a number of unsuccessful validation attempts. For example, the customer may be allowed three unsuccessful validation attempts before the transaction is automatically cancelled by the financial transaction machine and the code invalidated such that it cannot be used.

At block 220, the number of unsuccessful validation attempts is checked. If the number of allowed attempts has not been exceeded, then the method returns to block 210 to allow for reentry of the required information. Upon exceeding the number of unsuccessful validation attempts, the transaction is cancelled and the code is invalidated.

If a transaction is still desired, the customer has to start the process over again at block 202 to receive a new code.

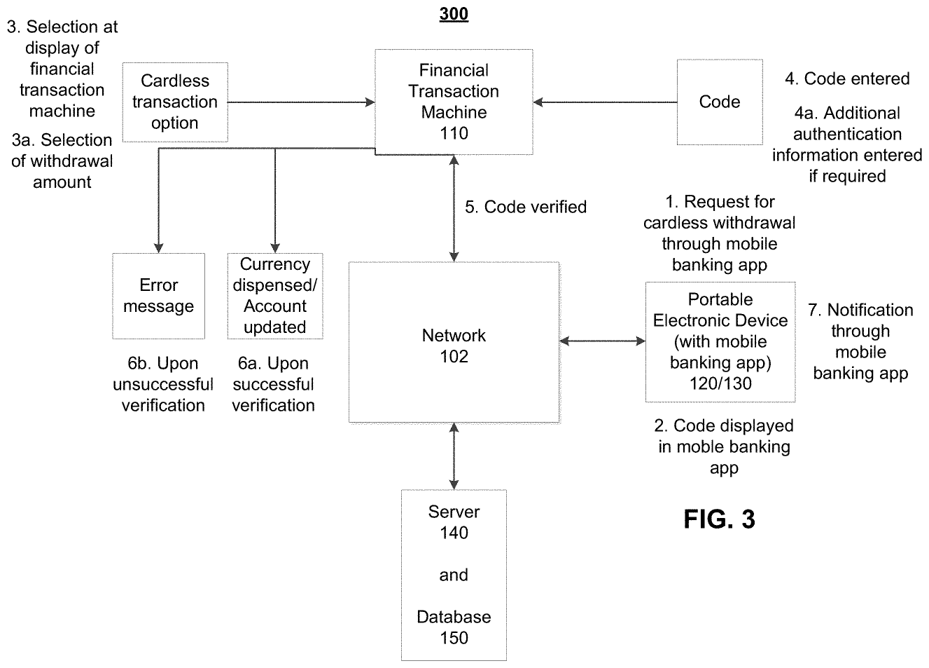

Referring to FIG. 3, a flow chart of a method of conducting a cardless withdrawal according to exemplary embodiments is depicted.

As depicted in the method 300, at 1, a customer may request a cardless withdrawal through a mobile banking application installed on a portable electronic device; the request may include an amount of currency desired to be withdrawn and/or an account from which the currency is to be withdrawn. At 2, a code may be displayed in the mobile banking application; the code may remain accessible in the mobile banking application until completion of the transaction, or after it has been invalidated or expired as described herein. At 3, once the customer is at an appropriate financial transaction machine, the customer may select a cardless transaction option at the financial transaction device. The appropriate transaction machine may be one associated with financial institution or one that connects to the financial institution. At 3a, an amount for withdrawal may be selected, if required. For example, in various exemplary embodiments the amount for withdrawal may not be specified in the mobile banking application. In various exemplary embodiments, a preselected withdrawal amount may be confirmed following entry of the code in the following steps. At 4, the code is entered into the financial transaction machine. A prompt may be displayed requesting entry of the code following selection of the option at 3. Optionally at 4a, additional authentication information may be entered, if required. The additional information may be a cell phone number or a PIN or a password that is associated with the customer and presumably only known to the customer. At 5, the code (and optional authentication information, if entered) is verified. The verification may occur over the network as depicted. At 6a, upon a successful verification, currency is dispensed in accordance with the withdrawal request from the financial transaction machine. The account is updated and the code is marked as used. At 6b, upon an unsuccessful verification, an error message may be displayed. For example, an appropriate message may be displayed at the financial transaction machine indicating an invalid entry and the user may be given one or more opportunities to reenter the requested information. In various exemplary embodiments, the code may be invalidated and the transaction cancelled after a certain number of invalid entries. At 7, a notification of the results is received in the mobile banking application. In various exemplary embodiments, this notification may be received only if the withdrawal was unsuccessful. Accordingly, if the customer still desires the withdrawal, the process may be repeated with a new request through the mobile banking application.

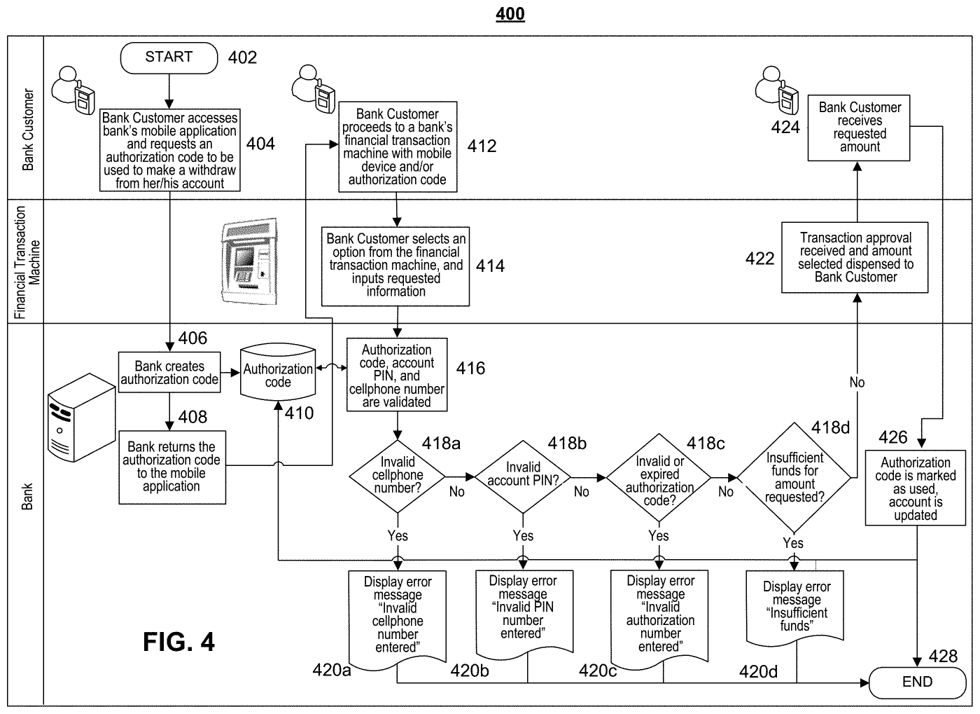

Referring to FIG. 4, an exemplary method 400 of conducting a cardless withdrawal is depicted. Exemplary method 400 may begin at 402.

At 404, a bank customer accesses a bank's mobile application on a mobile device and requests an authorization code to be used to make a withdrawal from his or her account. The mobile device may be a portable computing device, such as, but not limited to a smart phone or a tablet computing device. In various exemplary embodiments, the customer may input a withdrawal amount.

At 406, the bank creates the authorization code in response to the request. The authorization code may be randomly generated in response to the request. The code may be as described above with respect to the method 200.

At 408, the bank returns the authorization code to the mobile application. The authorization code is presented to the customer in the mobile application.

At 410, the authorization code is stored by the bank. The code may be stored in a database. The database may be accessed by 416 and/or 426 as depicted in FIG. 4.

At 412, the bank customer proceeds to a bank's financial transaction machine with the mobile device having the authorization code. In various exemplary embodiments, the bank customer may transcribe or memorize the authorization code and thus not require the mobile device with them when they proceed to the financial transaction machine.

At 414, the bank customer selects an option from the financial transaction machine, inputs requested information. This information may include: his/her cellphone number, account PIN, and authorization code. In various exemplary embodiments, only the code may be required. In various exemplary embodiments, only the code and one of the cellphone number and PIN may be required. In various exemplary embodiments, a withdrawal amount may be selected.

At 416, the authorization code, account PIN, and cellphone number are validated. This validation may occur remotely from the financial transaction machine as depicted in the method 400. In various exemplary embodiments, the validation may occur locally at the financial transaction machine. The validation may occur both locally and remotely. For example, the authorization code may be compared to the previously stored authorization code requested by the bank customer above. The other information may be validated against data stored by the bank associated with the bank customer.

At 418a, 418b, 418c, and 418d, the decision points for each of the validated information sets is depicted. If any of the entered information is invalid, an error message is displayed as depicted at 420a, 420b, 420c, and 420d and the method 400 ends at 428. If the bank customer still desires to conduct the withdrawal, the bank customer can begin the method again at 402. The validation error messages at 420a, 420b, 420c, and 420d are exemplary and non-limiting. Other message terminology is possible in various exemplary embodiments.

In various exemplary embodiments, the bank customer may be given the opportunity to reenter the authorization code and other information following an invalid entry. The method 400 may then go from 420a, 420b, or 420c to 414 to allow for reentry of the information. In the event the insufficient funds in the account for the requested withdrawal at 418d, the message 420d may be displayed. In this situation, the customer may be given the opportunity to enter a new withdrawal amount. In various exemplary embodiments, the customer may not have to reenter the authentication information with the new withdrawal amount.

Upon successful validation of the information, the method continues at 422. At 422, the financial transaction machine receives transaction approval and dispenses the amount selected by the bank customer.

At 424, the bank customer receives the requested amount.

At 426, the authorization code is marked as used in the database (at 410) and the account is updated. By marking the authorization code as used, the code is not capable of being used for the requested transaction.

At 428, the method 400 ends.

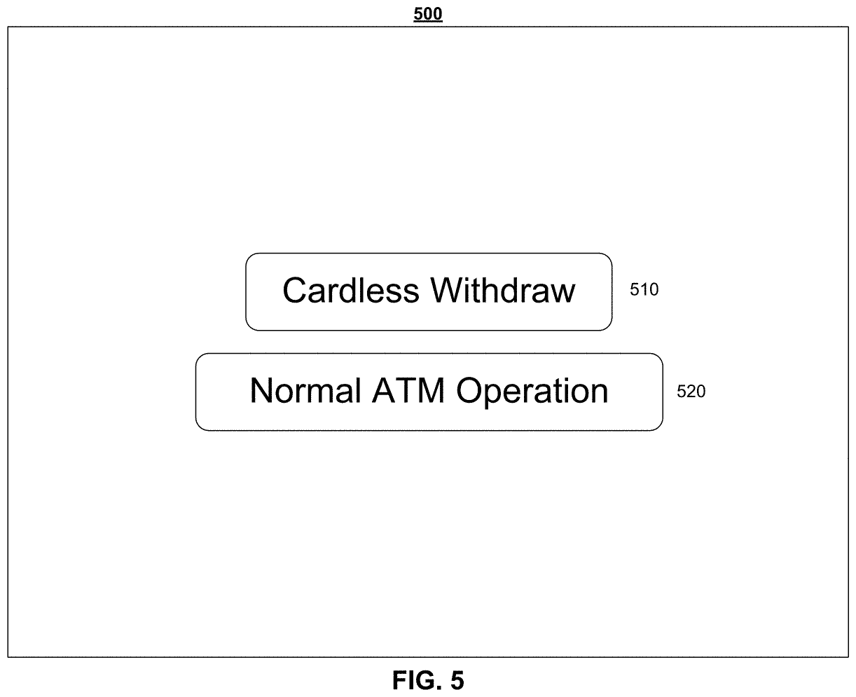

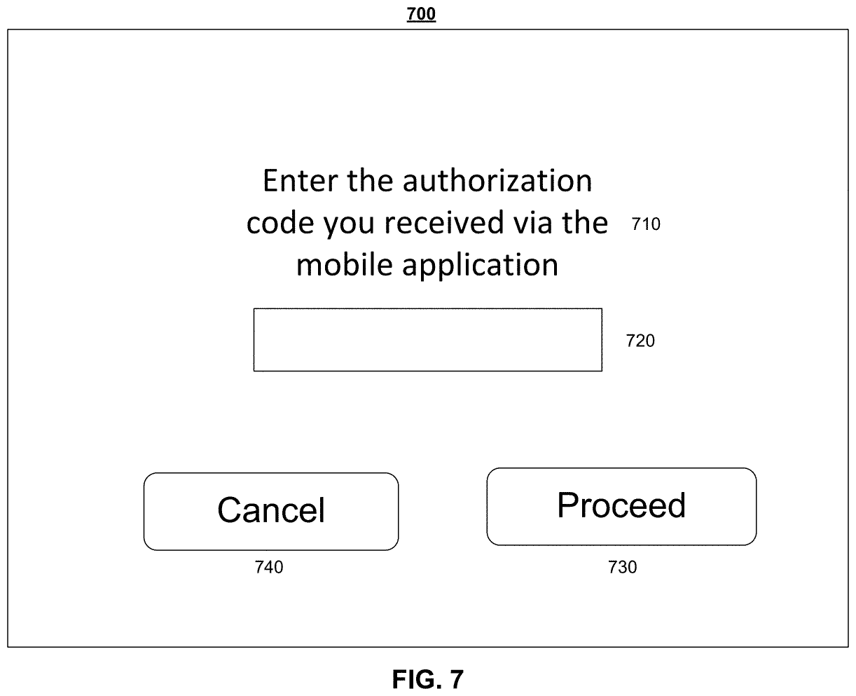

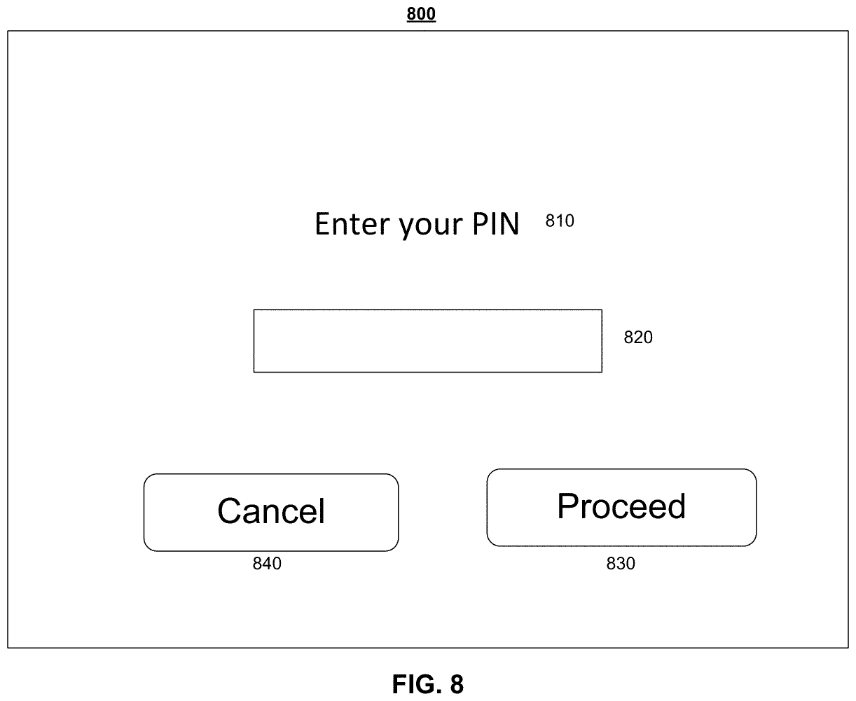

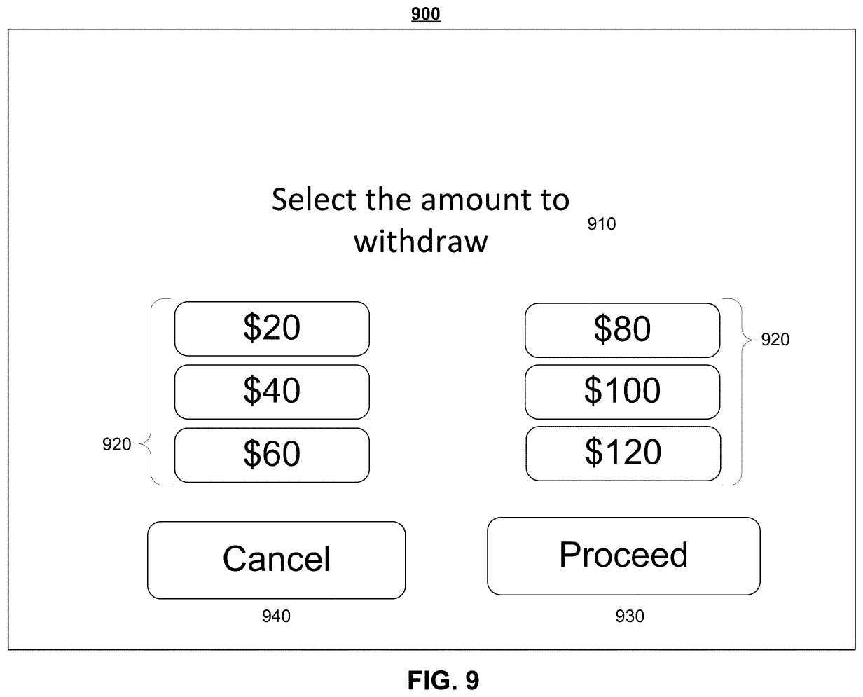

FIGS. 5 through 9 depict exemplary interfaces for entry of information at a financial transaction machine. These exemplary interfaces may be used with the methods described herein. It should be appreciated that the interfaces are exemplary and non-limiting, as the interfaces may contain additional buttons or other items beyond those depicted.

Interface 500 is a selection interface for choosing a cardless withdrawal or normal operation. The interface may present two options 510 and 520 as depicted. One option, such as option 510, may be for cardless withdrawal. The second option, such as option 520, may be for normal operation of the financial transaction machine. The interface 500 may be displayed at the financial transaction machine upon a user approaching the device. In various exemplary embodiments, the user may be required to select a first option for selecting different modes of operation. For example, the options may include one of “cardless cash,” “cardless withdraw,” “cardless withdrawal,” “cardless operation,” or “mobile cash.”

Interface 600 is an interface for entry of a cellphone number. The interface 600 may present an interface for entry of a user's cellphone number. The cellphone number may be the cellphone number associated with the mobile device that the mobile application is installed upon. The interface may have a prompt 610 requesting the cellphone number and an entry box 620 for entry of the number. A proceed button 630 and a cancel button 640 may be presented.

Interface 700 is an interface for entry of an authorization code. The interface 700 may present an interface for entry of the authorization code for the transaction. The interface may have a prompt 710 requesting the code and an entry box 720 for entry of the code. A proceed button 730 and a cancel button 740 may be presented.

Interface 800 is an interface for entry of a PIN number. The interface 800 may present an interface for entry of a user's PIN number associated with the account. The interface may have a prompt 810 requesting the PIN and an entry box 820 for entry of the PIN. A proceed button 830 and a cancel button 840 may be presented.

Interface 900 is an interface for selecting a withdrawal amount. The interface 900 may present options for selection of an amount for withdrawal. The interface may have a prompt 910 requesting the selection and a series of options 920 for withdrawal amounts. A proceed button 930 and a cancel button 940 may be presented.

It should be appreciated that while amounts in increments of $20 are depicted, other increments are possible, depending upon the currency dispensing capabilities of the financial transaction machine.

In various exemplary embodiments, the interface 900 may allow for entry of a specific amount.

According to exemplary embodiments, if the “cancel” option is selected in any of the interfaces 600, 700, 800, and 900, then the cardless withdrawal is cancelled.

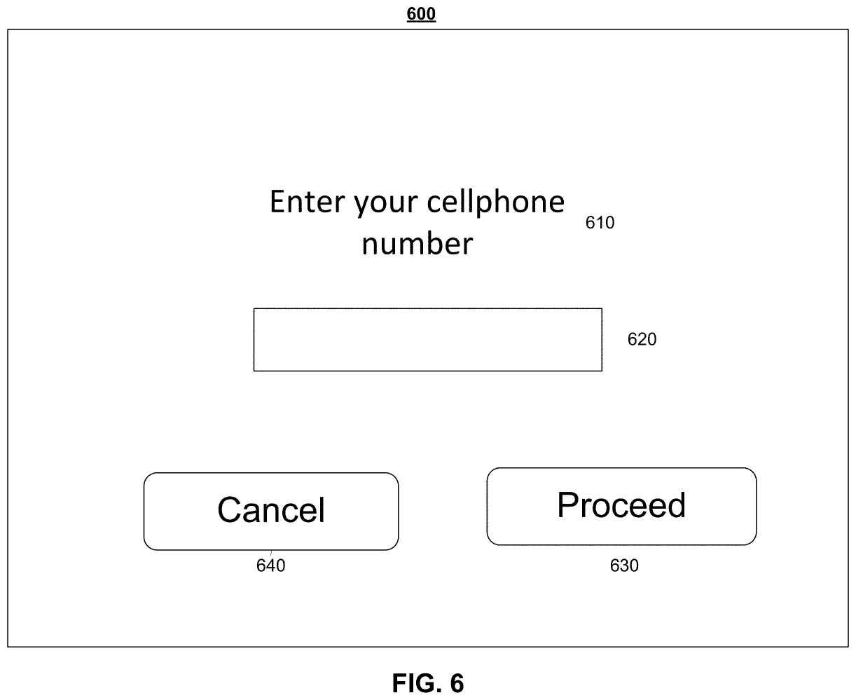

It should be appreciated that the interfaces 600. 700, 800, and 900 may be presented in any order. Accordingly, the order of FIGS. 6-9, the layouts depicted, labels, and content is meant to be exemplary and non-limiting. It should be appreciated that while the interfaces of FIGS. 5 through 9 are shown as screen interfaces which may be touch screen interfaces, the interfaces may use designated function buttons for selection of options.

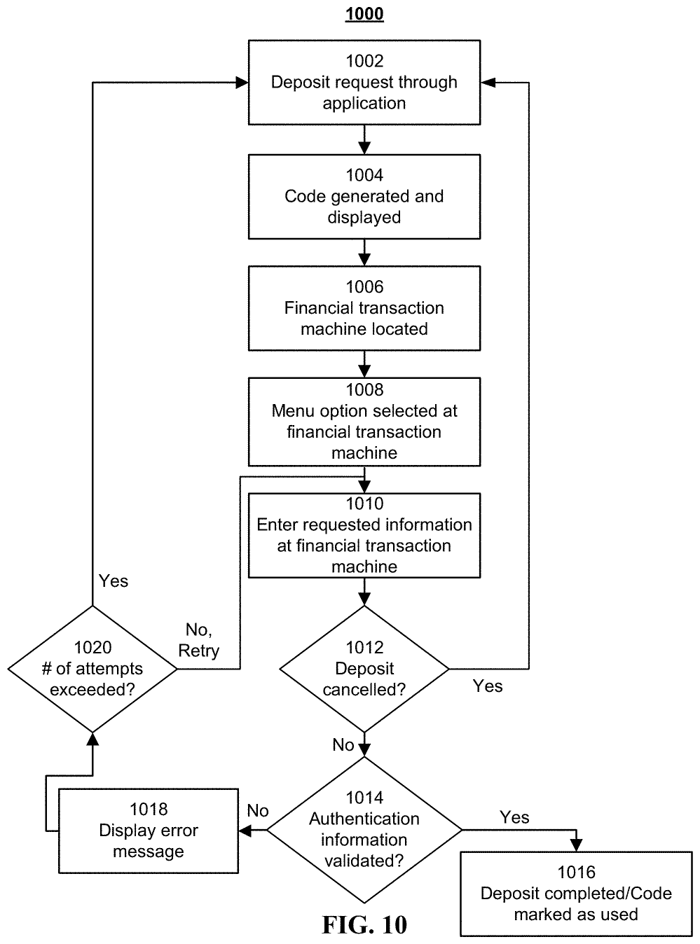

Referring to FIG. 10, an exemplary method 1000 of conducting a cardless deposit is depicted. Exemplary method 1000 may begin at block 1002.

At block 1002, a customer submits a deposit request for one of her/his accounts using a mobile application. An account may be selected. The mobile application may be one provided by a financial institution with which the customer has one or more accounts. The mobile application may be installed on a portable electronic device. For example, the portable electronic device may be a tablet computing device or smartphone. The mobile application may have an option supporting the method 1000 described herein. For example, the mobile application may have a “cardless deposit” or “mobile deposit” option.

These options may require additional security and/or authentication actions by the customer. The mobile application may require the customer to enter a username and/or password to access the option for authentication purposes. In various exemplary embodiments, this username and/or password may be in addition to a log in required to access the mobile application itself. In various exemplary embodiments, an access code may be required to be entered to access the option. This access code may be separate from the customer's password and the access code may be preconfigured by the customer through a website. The access code may be assigned by the financial institution.

The customer, as part of the transaction request, may be requested to enter an amount for deposit.

As part of the request, the mobile application may communicate with the financial institution. For example, the mobile application may communicate over a network, such as the network 102, with a server, such as the server 140. The communication may be necessary to transmit the details of the request input to the mobile application the financial institution. In various exemplary embodiments, the financial institution may process the request and may send a confirmation or acknowledge signal to the mobile application over the network.

At block 1004, a code is generated and displayed through the mobile application. The code may be of any length or composition. For example, the code may be numeric and 8-10 digits in length. In various exemplary embodiments, the code may be alpha-numeric. The code may have checksums embedded on it, combining attributes such as account number, timestamp, and information.

The financial institution may generate the code in response to the received deposit request and transmit the code to the mobile application over the network. In various exemplary embodiments, the code may be locally generated by the mobile application. In these embodiments, where the code is locally generated, the mobile application may transmit the code to the financial institution. The financial institution may store the code and the deposit request associated therewith for future use with method described herein. In various exemplary embodiments, the financial institution may transmit the code and the deposit request to its network of financial transaction machines. In various exemplary embodiments, if a specific financial transaction machine or a set of financial transaction machines is indicated, as described below, the code and deposit request may be transmitted to those particular financial transaction machines.

The exchange of data between the mobile application and the financial institution may be secure (such as the deposit request and the code exchange). For example, the exchange of data may be encrypted. The mobile application may use the capabilities of the portable electronic device, on which it is installed, for communications with the network (e.g., transmitted and receiving data).

The code may be a one-time use code. The code may be valid for a certain amount of time. For example, the code may be valid for period of hours or may be valid for a day. Other time periods are possible. In various exemplary embodiments, the customer may select a time period for validity. The time period may be predetermined by the customer as part of the customer's preferences for the mobile application. The time period may be configured during each transaction request.

After the period of time expires, the code expires and is no longer valid. In various exemplary embodiments, the code may be used in any financial transaction machine associated with the financial institution or a financial transaction machine that directly or indirectly connects to the financial institution using a payment network, processor, or gateway. In various exemplary embodiments, a specific financial transaction machine may be designated by the customer for the deposit. For example, the mobile application may prompt the customer to select a specific financial transaction machine at which to conduct the transaction. A map-based interface may be used to allow the customer to locate a preferred location. The customer may be able to select a particular geographic area instead of a particular location. In various exemplary embodiments, a drop-down listing or other interface may be used to present the customer with locations for selection. In various exemplary embodiments, the customer may be given the option of selecting a particular financial transaction machine, a particular area, or having the code be valid at any financial transaction machine.

The code may be accessible through the mobile application for the duration of its validity to allow the customer access to it.

At block 1006, an appropriate financial transaction machine is located.

At block 1008, a designated menu option is selected from the interface of the financial transaction machine to conduct the transaction. For example, the designated menu option may be labeled “cardless deposit” or “mobile deposit.” The option may be selected from a touch screen, a designated function key/button, or using another appropriate interface. The financial transaction machine may then prompt the customer to enter authentication information to conduct the transaction. The authentication information requested may include the code received by the customer.

At block 1010, the requested information is entered. For example, the customer may enter the code. In various exemplary embodiments, additional authentication information may be required to be entered as further validation of the customer's identify, such as a cell phone number associated with the account, and the customer's PIN. This information is presumably something only the customer knows. In various exemplary embodiments, the information may be requested in different orders. For example, the code may be requested prior to other information. The cell phone number may be requested prior to the code and then the PIN requested after the code. Other orders are possible.

In various exemplary embodiments, the customer may be requested to enter an amount for deposit at the financial transaction machine. As described above, the customer may not specify an amount at the time of the request. The customer may specify an amount at the financial transaction machine, either before or after entry of any requested authentication information. In various exemplary embodiments, the customer may alter the amount for deposit previously specified in the mobile application. The customer may be presented with the preselected deposit amount for confirmation following entry of the authentication information.

At block 1012, the deposit may be cancelled. The customer may be presented with a cancellation option at the financial transaction machine. The cancellation option may be available at various points in the method. If the deposit is not cancelled, then the method continues to block 1014. In various exemplary embodiments, once the transaction is cancelled, the code is invalidated such that it cannot be used again for the transaction.

In various exemplary embodiments, the customer may have the option of cancelling the transaction through the mobile application. This cancellation causes the code to be invalidated.

If the customer desires another transaction, then the method is begun again at block 1002.

At block 1014, the authentication information is validated. The financial transaction machine may transmit the received authentication information over a network. For example, the network 102 may be used. The transmitted information may be remotely processed and validated by the financial institution. For example, the server 140 may process and validate the information. The results of the validation may be transmitted back to the financial transaction machine over the network. In various exemplary embodiments, the data transmitted between the financial transaction machine and the financial institution over the network may be secure. For example, the data may be encrypted.

In various exemplary embodiments, the financial transaction machine may have previously received the code and deposit request over the network. The entered authentication information may be locally processed and validated by the financial transaction machine. In various exemplary embodiments, a combination of local and remote processing and validation may occur. For example, the code may be validated locally (if previously received) and the authentication information may be remotely validated.

At block 1016, upon successful authentication, the financial transaction machine can accept the deposit through a designated opening, the code is marked as used by the system, the account is updated, and a notification is sent to the mobile application. The notification may be an indication of a successful completion of the deposit.

At block 1018, upon unsuccessful authentication, an error message displayed. A notification may be sent to the mobile application. The notification may be an indication of an unsuccessful deposit request. The customer may be allowed a number of unsuccessful validation attempts. For example, the customer may be allowed three unsuccessful validation attempts before the transaction is automatically cancelled by the financial transaction machine and the code invalidated such that it cannot be used.

At block 1020, the number of unsuccessful validation attempts is checked. If the number of allowed attempts has not been exceeded, then the method returns to block 1010 to allow for reentry of the required information. Upon exceeding the number of unsuccessful validation attempts, the transaction is cancelled and the code is invalidated.

If a transaction is still desired, the customer has to start the process over again at block 1002 and receive a new code.

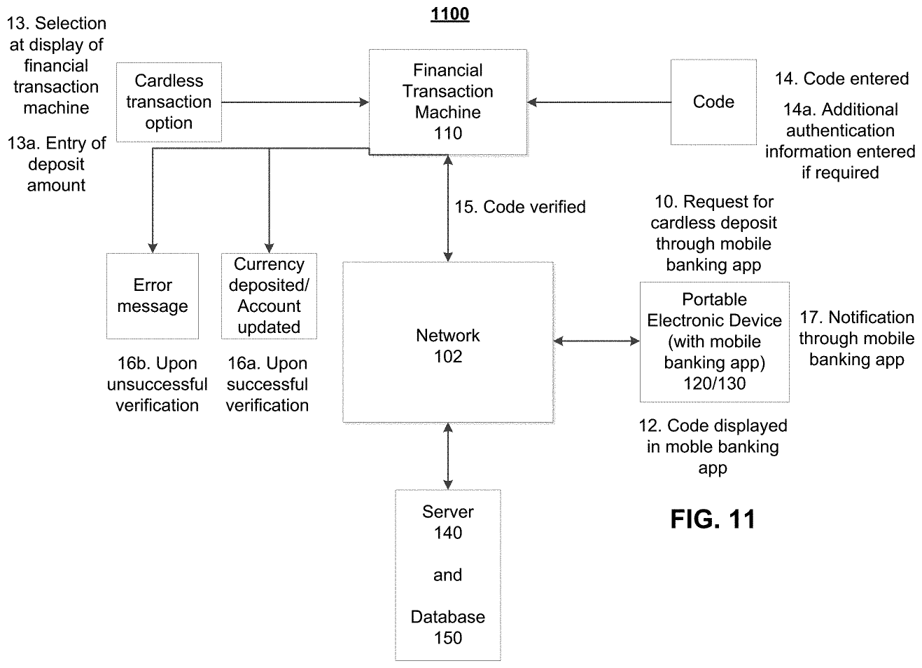

Referring to FIG. 11, a flow chart of a method for conducting a cardless deposit according to exemplary embodiments is depicted.

As depicted in the method 1100, at 10, a customer may request a cardless deposit through a mobile banking application installed on a portable electronic device; the request may include an amount of currency desired to be deposited and/or an account into which the currency is to be deposited. At 12, a code may be displayed in the mobile banking application; the code may remain accessible in the mobile banking application until completion of the transaction, or after it has been invalidated or expired as described herein. At 13, once the customer is at an appropriate financial transaction machine, the customer may select a cardless transaction option at the financial transaction device. The appropriate transaction machine may be one associated with financial institution or one that connects to the financial institution. At 13a, an amount for deposit may be entered, if required. For example, in various exemplary embodiments the amount for deposit may not be specified in the mobile banking application. In various exemplary embodiments, a predetermined deposit amount may be confirmed following entry of the code in the following steps. At 14, the code is entered into the financial transaction machine. A prompt may be displayed requesting entry of the code following selection of the option at 13. Optionally at 14a, additional authentication information may be entered, if required. The additional information may be a cell phone number or a PIN or a password that is associated with the customer and presumably only known to the customer. At 15, the code (and optional authentication information, if entered) is verified. The verification may occur over the network as depicted. At 16a, upon a successful verification, the deposit is made into the financial transaction machine in accordance with the deposit request. The account is updated and the code is marked as used. At 16b, upon an unsuccessful verification, an error message may be displayed. For example, an appropriate message may be displayed at the financial transaction machine indicating an invalid entry and the user may be given one or more opportunities to reenter the requested information. In various exemplary embodiments, the code may be invalidated and the transaction cancelled after a certain number of invalid entries. At 17, a notification of the results is received in the mobile banking application. In various exemplary embodiments, this notification may be received only if the deposit was unsuccessful. Accordingly, if the customer still desires the deposit, the process may be repeated with a new request through the mobile banking application.

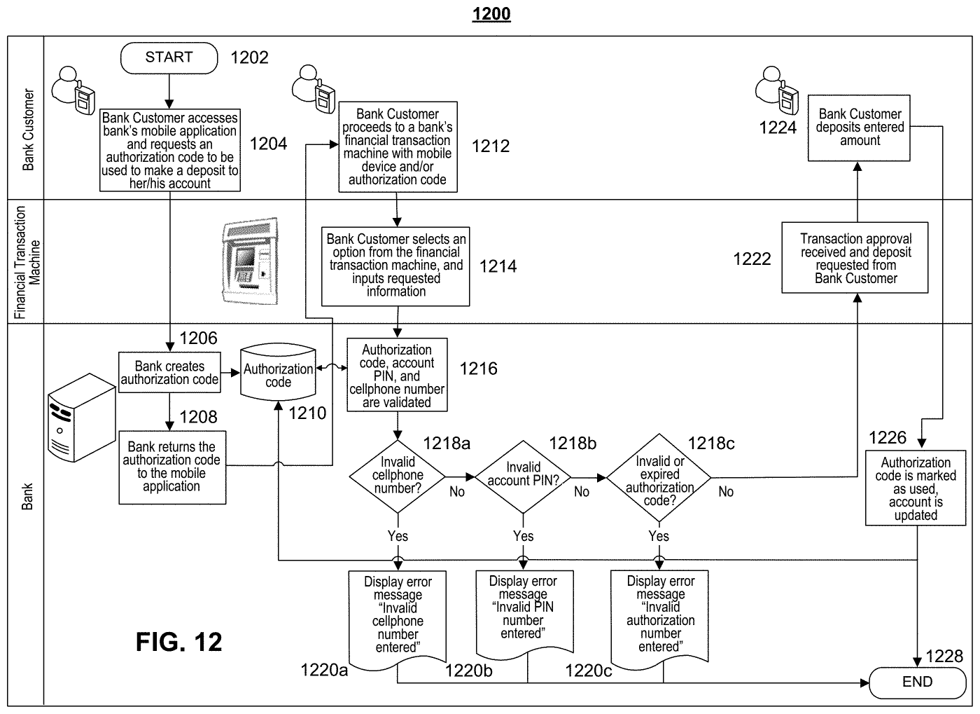

Referring to FIG. 12, an exemplary method 1200 of conducting a cardless deposit is depicted. Exemplary method 1200 may begin at 1202.

At 1204, a bank customer accesses a bank's mobile application on a mobile device and requests an authorization code to be used to make a deposit into his or her account. The mobile device may be a portable computing device, such as, but not limited to a smart phone or a tablet computing device. In various exemplary embodiments, the customer may input a deposit amount.

At 1206, the bank creates the authorization code in response to the request. The authorization code may be randomly generated in response to the request. The code may be as described above with respect to the method 1000.

At 1208, the bank returns the authorization code to the mobile application. The authorization code is presented to the customer in the mobile application.

At 1210, the authorization code is stored by the bank. The code may be stored in a database. The database may be accessed by 1216 and/or 1226 as depicted in FIG. 12.

At 1212, the bank customer proceeds to a bank's financial transaction machine with the mobile device having the authorization code. In various exemplary embodiments, the bank customer may transcribe or memorize the authorization code and thus not require the mobile device with them when they proceed to the financial transaction machine.

At 1214, the bank customer selects an option from the financial transaction machine, inputs requested information. This information may include: his/her cellphone number, account PIN, and authorization code. In various exemplary embodiments, only the code may be required. In various exemplary embodiments, only the code and one of the cellphone number and PIN may be required. In various exemplary embodiments, a deposit amount may be entered.

At 1216, the authorization code, account PIN, and cellphone number are validated. This validation may occur remotely from the financial transaction machine as depicted in the method 1200. In various exemplary embodiments, the validation may occur locally at the financial transaction machine. The validation may occur both locally and remotely. For example, the authorization code may be compared to the previously stored authorization code requested by the bank customer above. The other information may be validated against data stored by the bank associated with the bank customer. 1001391 At 1218a, 1218b, and 1218c, the decision points for each of the validated information sets is depicted. If any of the entered information is invalid, an error message is displayed as depicted at 1220a, 1220b, and 1220c and the method 1200 ends at 1228. If the bank customer still desires to conduct the deposit, the bank customer can begin the method again at 1202. The validation error messages at 1220a, 1220b, and 1220c are exemplary and non-limiting. Other message terminology is possible in various exemplary embodiments.

In various exemplary embodiments, the bank customer may be given the opportunity to reenter the authorization code and other information following an invalid entry. The method 1200 may then go from 1220a, 1220b, or 1220c to 1214 to allow for reentry of the information.

Upon successful validation of the information, the method continues at 1222. At 1222, the financial transaction machine receives transaction approval and requests the deposit of the amount entered by the bank customer.

At 1224, the bank customer deposits the entered amount.

At 1226, the authorization code is marked as used in the database (at 1210) and the account is updated. By marking the authorization code as used, the code is not capable of being used for the requested transaction.

At 1228, the method 1200 ends.

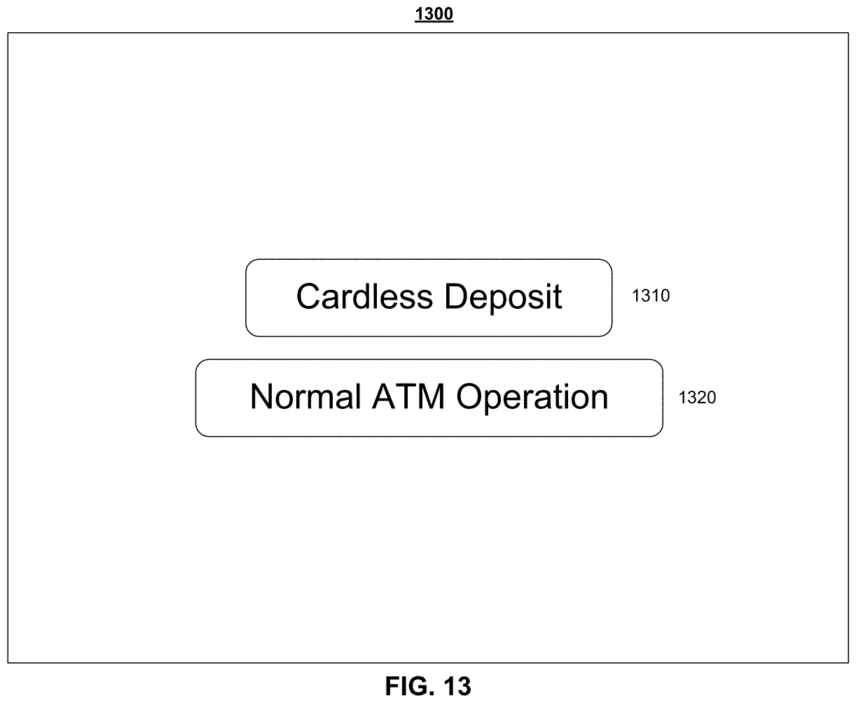

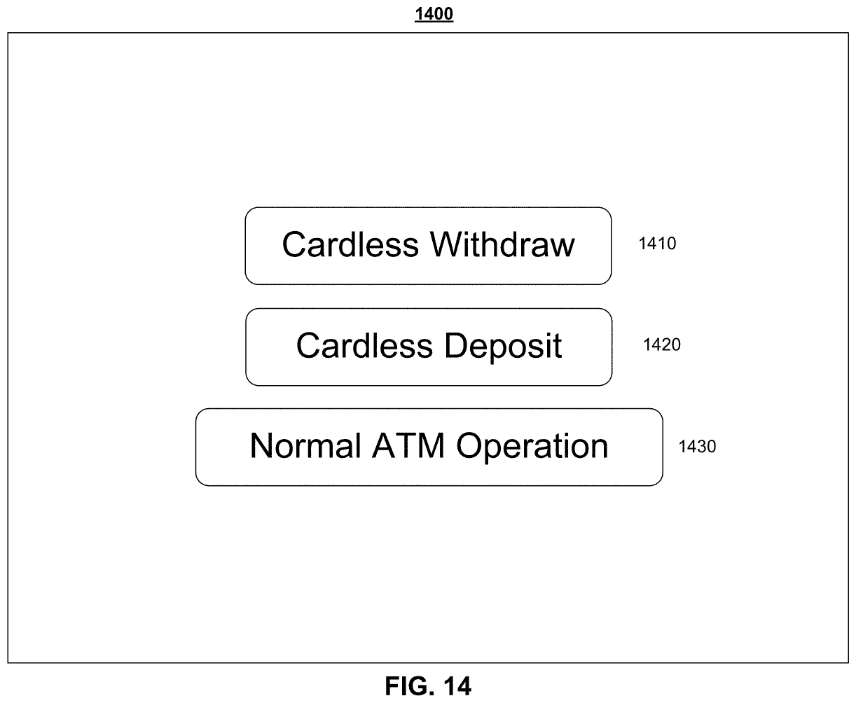

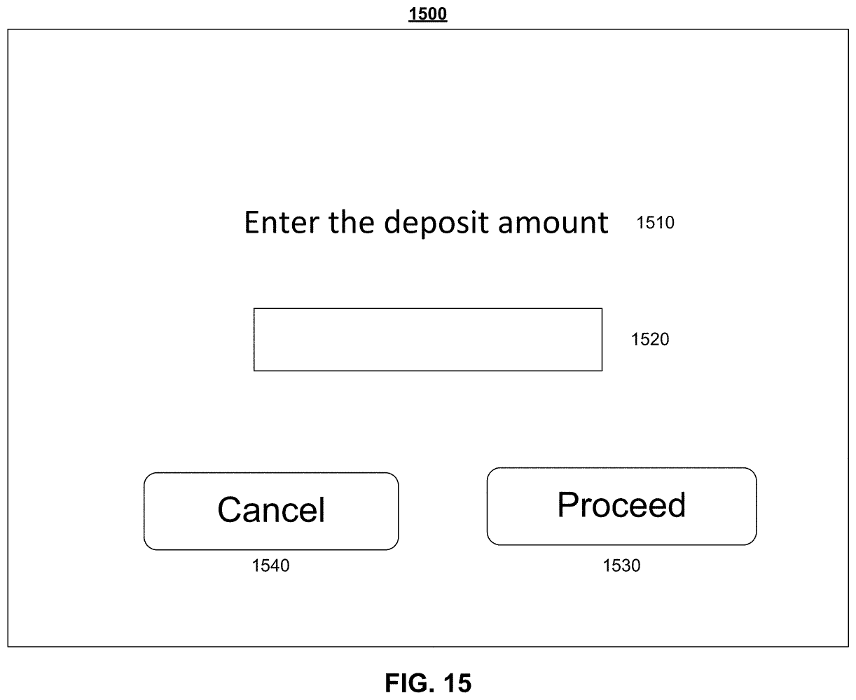

FIGS. 13 through 15 depict exemplary interfaces for entry of information at a financial transaction machine. These exemplary interfaces may be used with the methods described herein. It should be appreciated that the interfaces are exemplary and non-limiting, as the interfaces may contain additional buttons or other items beyond those depicted.

Interface 1300 is a selection interface for choosing a cardless deposit or normal operation. The interface may present two options 1310 and 1320 as depicted. One option, such as option 1310, may be for cardless deposit. The second option, such as option 1320, may be for normal operation of the financial transaction machine. The interface 1300 may be displayed at the financial transaction machine upon a user approaching the device. In various exemplary embodiments, the user may be required to select a first option for selecting different modes of operation. For example, the options may include “cardless deposit.”

The interfaces depicted in FIGS. 6 through 8 may be used with the cardless deposit option for entry of the required information.

Interface 1400 is a selection interface for choosing a cardless transaction or normal operation. The interface may present three options 1410, 1420, and 1430 as depicted. One option, such as option 1410, may be for cardless withdrawal. The second option, such as option 1420, may be for cardless deposit. The third option, such as option 1430, may be for normal operation of the financial transaction machine. The interface 1400 may be displayed at the financial transaction machine upon a user approaching the device. In various exemplary embodiments, the user may be required to select a first option for selecting different modes of operation. For example, the options may include “cardless deposit” or “cardless withdrawal.”

Interface 1500 is an interface for entry of a deposit amount. The interface 1500 may present an interface for entry of an amount for deposit. The interface may have a prompt 1510 requesting the deposit amount and an entry box 1520 for entry of the amount. A proceed button 1530 and a cancel button 1540 may be presented.

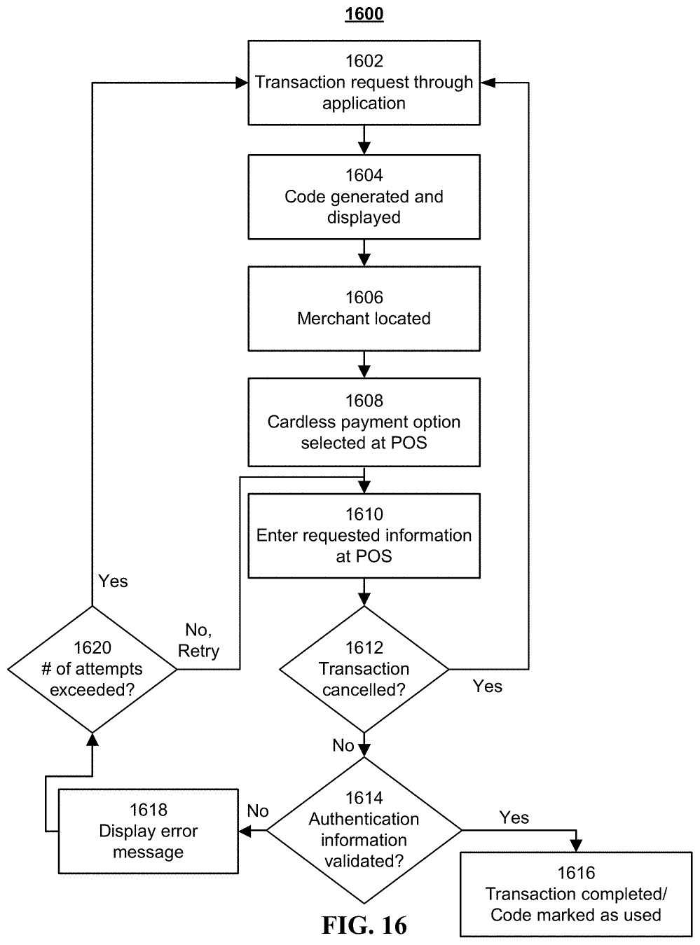

Referring to FIG. 16, an exemplary method 1600 of conducting a cardless transaction is depicted. Exemplary method 1600 may begin at block 1602.

At block 1602, a customer submits a transaction request using a mobile application. An account for the transaction may be selected. For example, a checking or savings account may be selected. The transaction may be for a purchase at a merchant. The purchase may be for goods and/or services. The mobile application may be one provided by a financial institution with which the customer has one or more accounts. The mobile application may be installed on a portable electronic device. For example, the portable electronic device may be a tablet computing device or smartphone. The mobile application may have an option supporting the method 1600 described herein. For example, the mobile application may have a “cardless transaction” option.

These options may require additional security and/or authentication actions by the customer. The mobile application may require the customer to enter a username and/or password to access the option for authentication purposes. In various exemplary embodiments, this username and/or password may be in addition to a log in required to access the mobile application itself. In various exemplary embodiments, an access code may be required to be entered to access the option. This access code may be separate from the customer's password and the access code may be preconfigured by the customer through a website. The access code may be assigned by the financial institution.

The customer, as part of the transaction request, may be requested to enter an amount for the transaction. The amount may be a maximum amount for the transaction. For example, the amount may be a type of credit limit for the transaction. In various exemplary embodiments, the amount may be the amount of the transaction. In various exemplary embodiments, the customer may be requested to enter a specific merchant with whom the transaction is to be conducted. The financial institution may have a partnership with specific merchants for the conduct of cardless transactions using the method described herein. The mobile application may provide a listing of these specific merchants. In various exemplary embodiments, the transaction may be conducted at any merchant that accepts credit transactions from the financial institution or the designated credit card network as described below.

As part of the request, the mobile application may communicate with the financial institution. For example, the mobile application may communicate over a network, such as the network 102, with a server, such as the server 140. The communication may be necessary to transmit the details of the request input to the mobile application the financial institution. In various exemplary embodiments, the financial institution may process the request and may send a confirmation or acknowledge signal to the mobile application over the network.

At block 1604, a code is generated and displayed through the mobile application. The code may be in the form of a credit card number. For example, the code may be numeric and 16 digits in length. The code may serve as a temporary credit card number. The code may have checksums embedded on it, combining attributes such as account number, timestamp, and information. The code may be capable of being used as a credit card number for the conduct of the designated transaction. The code may be associated with a particular credit card network or processor.

The financial institution may generate the code in response to the received transaction request and transmit the code to the mobile application over the network. In various exemplary embodiments, the code may be locally generated by the mobile application. In these embodiments, where the code is locally generated, the mobile application may transmit the code to the financial institution. The financial institution may store the code and the transaction request associated therewith for future use with method described herein. In various exemplary embodiments, the specific merchant may be designated and the code and transaction request may be transmitted to that particular merchant.

The exchange of data between the mobile application and the financial institution may be secure (such as the deposit request and the code exchange). For example, the exchange of data may be encrypted. The mobile application may use the capabilities of the portable electronic device, on which it is installed, for communications with the network (e.g., transmitted and receiving data).

The code may be a one-time use code. The code may be valid for a certain amount of time. For example, the code may be valid for period of hours or may be valid for a day. Other time periods are possible. In various exemplary embodiments, the customer may select a time period for validity. The time period may be predetermined by the customer as part of the customer's preferences for the mobile application. The time period may be configured during each transaction request.

After the period of time expires, the code expires and is no longer valid. In various exemplary embodiments, the code may be used for a transaction at a merchant. In various exemplary embodiments, a specific merchant may be designated by the customer. For example, the mobile application may prompt the customer to select a specific merchant at which to conduct the transaction. A map-based interface may be used to allow the customer to locate a preferred location associated with the merchant. The customer may be able to select a particular geographic area instead of a particular location. In various exemplary embodiments, a drop-down listing or other interface may be used to present the customer with locations for selection. In various exemplary embodiments, the customer may be given the option of selecting a merchant, a particular area, or having the code be valid at any participating merchant.

The code may be accessible through the mobile application for the duration of its validity to allow the customer access to it.

At block 1606, an appropriate merchant is located.

At block 1608, a cardless payment option is selected at the point of sale (POS) at the merchant to conduct the transaction. For example, the designated menu option may be labeled “cardless transaction” at the POS device. The option may be selected by the customer at a payment terminal associated with the POS device. In various exemplary embodiments, an employee of the merchant may select the option at the POS device. The option may be selected from a touch screen, a designated function key/button, or using another appropriate interface. The POS device may then prompt the customer to enter authentication information to conduct the transaction. The authentication information requested may include the code received by the customer.

At block 1610, the requested information is entered at the POS device. It should be appreciated that references to the POS device include attached peripherals, such as customer payment terminals. For example, the customer may enter the code. The customer may provide the code to an employee for entry. In various exemplary embodiments, additional authentication information may be required to be entered as further validation of the customer's identify, such as a cell phone number associated with the account, and the customer's PIN. This information is presumably something only the customer knows. In various exemplary embodiments, the information may be requested in different orders. For example, the code may be requested prior to other information. The cell phone number may be requested prior to the code and then the PIN requested after the code. Other orders are possible.

At block 1612, the transaction may be cancelled. The customer may be presented with a cancellation option at the POS. The cancellation option may be available at various points in the method. If the transaction is not cancelled, then the method continues to block 1614. In various exemplary embodiments, once the transaction is cancelled, the code is invalidated such that it cannot be used again for the transaction.

In various exemplary embodiments, the customer may have the option of cancelling the transaction through the mobile application. This cancellation causes the code to be invalidated.

If the customer desires another transaction, then the method is begun again at block 1602.

At block 1614, the authentication information is validated. The POS device may transmit the received authentication information over a network. For example, the network 102 may be used. The transmitted information may be remotely processed and validated by the financial institution. For example, the server 140 may process and validate the information. The results of the validation may be transmitted back to the POS device over the network. In various exemplary embodiments, the data transmitted between the POS device and the financial institution over the network may be secure. For example, the data may be encrypted.

In various exemplary embodiments, the POS device may have previously received the code and transaction request over the network The entered authentication information may be locally processed and validated by the POS device. In various exemplary embodiments, a combination of local and remote processing and validation may occur. For example, the code may be validated locally (if previously received) and the authentication information may be remotely validated.

At block 1616, upon successful authentication, the transaction is completed, the code is marked as used by the system, the account is updated, and a notification is sent to the mobile application. The notification may be an indication of a successful completion of the transaction. The transaction may be processed as a credit card transaction with the transaction amount being debited against the selected account.

At block 1618, upon unsuccessful authentication, an error message displayed. A notification may be sent to the mobile application. The notification may be an indication of an unsuccessful transaction request. The customer may be allowed a number of unsuccessful validation attempts. For example, the customer may be allowed three unsuccessful validation attempts before the transaction is automatically cancelled by the POS device and the code invalidated such that it cannot be used.

At block 1620, the number of unsuccessful validation attempts is checked. If the number of allowed attempts has not been exceeded, then the method returns to block 1610 to allow for reentry of the required information. Upon exceeding the number of unsuccessful validation attempts, the transaction is cancelled and the code is invalidated.

If a transaction is still desired, the customer has to start the process over again at block 1602 and receive a new code.

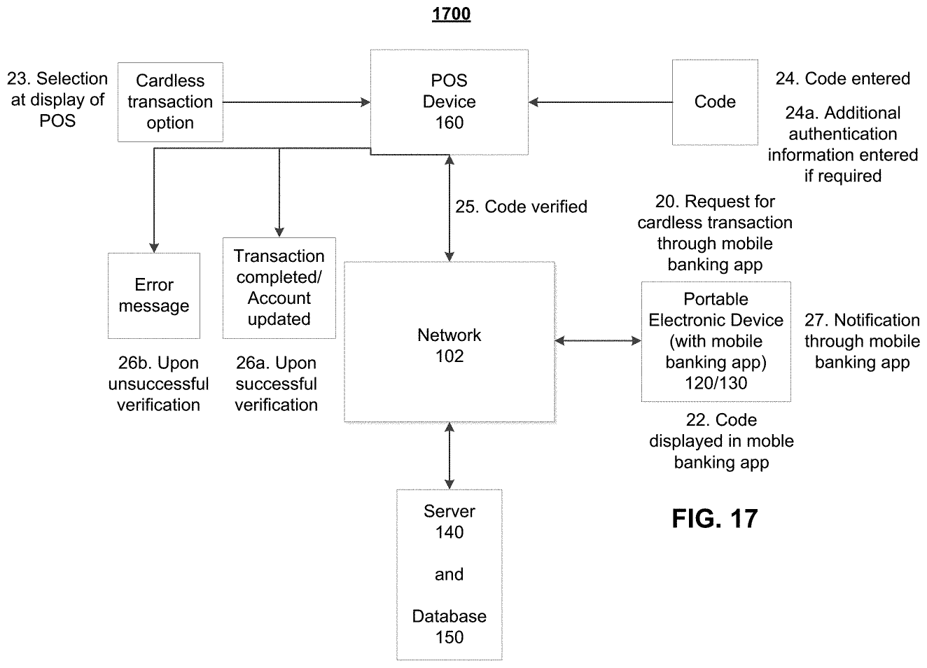

Referring to FIG. 17, a flow chart of a method of conducting a cardless transaction according to exemplary embodiments is depicted.

As depicted in the method 1700, at 20, a customer may request a cardless transaction through a mobile banking application installed on a portable electronic device; the request may include an amount of the transaction and/or a designation of a merchant for the transaction. At 22, a code may be displayed in the mobile banking application; the code may remain accessible in the mobile banking application until completion of the transaction, or after it has been invalidated or expired as described herein. At 23, once the customer is at an appropriate POS device, the customer may select a cardless transaction option at the POS device. At 24, the code is entered into the POS device. A prompt may be displayed requesting entry of the code following selection of the option at 23. Optionally at 24a, additional authentication information may be entered, if required. The additional information may be a cell phone number or a PIN or a password that is associated with the customer and presumably only known to the customer. At 25, the code (and optional authentication information, if entered) is verified. The verification may occur over the network as depicted. At 26a, upon a successful verification, the transaction is completed. The account is updated and the code is marked as used. At 26b, upon an unsuccessful verification, an error message may be displayed. For example, an appropriate message may be displayed at the POS device indicating an invalid entry and the user may be given one or more opportunities to reenter the requested information. In various exemplary embodiments, the code may be invalidated and the transaction cancelled after a certain number of invalid entries. At 27, a notification of the results is received in the mobile banking application. In various exemplary embodiments, this notification may be received only if the transaction was unsuccessful. Accordingly, if the customer still desires the transaction, the process may be repeated with a new request through the mobile banking application.

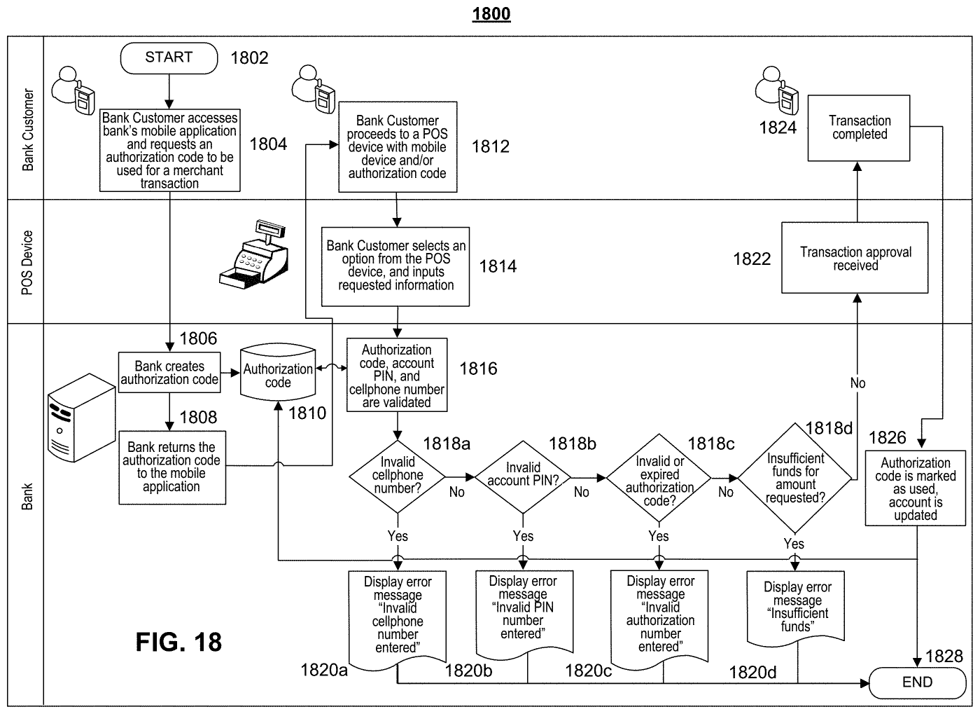

Referring to FIG. 18, an exemplary method 1800 of conducting a cardless transaction is depicted. Exemplary method 1800 may begin at 1802.

At 1804, a bank customer accesses a bank's mobile application on a mobile device and requests an authorization code to be used for a merchant transaction using one of his/her accounts. The mobile device may be a portable computing device, such as, but not limited to a smart phone or a tablet computing device. In various exemplary embodiments, the customer may input a transaction amount.

At 1806, the bank creates the authorization code in response to the request. The authorization code may be randomly generated in response to the request. The code may be as described above with respect to the method 1600.

At 1808, the bank returns the authorization code to the mobile application. The authorization code is presented to the customer in the mobile application.

At 1810, the authorization code is stored by the bank. The code may be stored in a database. The database may be accessed by 1816 and/or 1826 as depicted in FIG. 18.

At 1812, the bank customer proceeds to a merchant's POS device with the mobile device having the authorization code. In various exemplary embodiments, the bank customer may transcribe or memorize the authorization code and thus not require the mobile device with them when they proceed to the POS device.

At 1814, the bank customer selects an option from the POS device, inputs requested information. This information may include: his/her cellphone number, account PIN, and authorization code. In various exemplary embodiments, only the code may be required. In various exemplary embodiments, only the code and one of the cellphone number and PIN may be required. In various exemplary embodiments, a transaction amount may be entered.

At 1816, the authorization code, account PIN, and cellphone number are validated. This validation may occur remotely from the POS device as depicted in the method 1800. In various exemplary embodiments, the validation may occur locally at the POS device. The validation may occur both locally and remotely. For example, the authorization code may be compared to the previously stored authorization code requested by the bank customer above. The other information may be validated against data stored by the bank associated with the bank customer.

At 1818a, 1818b, 1818c, and 1818d, the decision points for each of the validated information sets is depicted. If any of the entered information is invalid, an error message may be displayed as depicted at 1820a, 1820b, and 1820c, and the method 1800 ends at 1828. If the bank customer still desires to conduct the transaction, the bank customer can begin the method again at 1802. The validation error messages at 1820a, 1820b, and 1820c are exemplary and non-limiting. Other message terminology is possible in various exemplary embodiments.

In various exemplary embodiments, the bank customer may be given the opportunity to reenter the authorization code and other information following an invalid entry. The method 1800 may then go from 1820a, 1820b, or 1820c to 1814 to allow for reentry of the information.

In the event the insufficient funds in the account for the requested transaction at 1818d, the message 1820d may be displayed. In this situation, the customer may be given the opportunity to enter a new transaction amount. In various exemplary embodiments, the customer may not have to reenter the authentication information with the new transaction amount.

Upon successful validation of the information, the method continues at 1822. At 1822, the POS device receives transaction approval.

At 1824, the transaction is completed and the customer receives the goods and/or services from the transaction.

At 1826, the authorization code is marked as used in the database (at 1810) and the account is updated. By marking the authorization code as used, the code is not capable of being used for the requested transaction.

At 1828, the method 1800 ends.

Exemplary embodiments may perform all communications related to the transaction within the mobile application. For example, communications via e-mail or text relating to the transaction (such as the deposit, withdrawal, or purchase) may not be used and instead communications within the mobile application may be relied upon.

Hereinafter, physical aspects of implementation of the exemplary embodiments will be described. As described above, exemplary methods may be computer implemented as a system. The system or portions of the system may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini-computer or mainframe for example, a programmed microprocessor, a micro-controller, a PICE (peripheral integrated circuit element), a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process.

It is appreciated that in order to practice the methods as described above, it is not necessary that the processors and/or the memories of the processing machine be physically located in the same geographical place. For example, each of the processors and the memories and the data stores used may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with further embodiments, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions. It is also appreciated that the data storage performed by two distinct components as described above may, in accordance with a further embodiment, be performed by a single component. Further, the data storage performed by one distinct component as described above may be performed by two distinct components.

Further, various technologies may be used to provide communication between the various processors and/or memories, as well as to allow the processors and/or the memories of the various exemplary embodiments to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of various exemplary embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of the various exemplary embodiments may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various exemplary embodiments. Illustratively, the programming language used may include assembly language, ActionScript, Ada, APL, Basic, C, C++, C#, COBOL, Ceylon, Dart, dBase, F#, Fantom, Forth, Fortran, Go, Java, Jquery, Modula-2, .NET, Objective C, Opa, Pascal, Prolog, Python, REXX, Ruby, Visual Basic, X10, and/or JavaScript, for example. Further, it is not necessary that a single type of instructions or single programming language be utilized in conjunction with the operation of the system and method of various exemplary embodiments. Rather, any number of different programming languages may be utilized as is necessary or desirable.

Also, the instructions and/or data used in the practice of the various exemplary embodiments may utilize any compression or encryption technique or algorithm, as may be desired. An encryption module might be used to encrypt data. Further, files or other data may be decrypted using a suitable decryption module, for example.

As described above, various exemplary embodiments may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the system.

Further, the memory or memories used in the processing machine that implements the various exemplary embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the various exemplary embodiments, a variety of “user interfaces” may be utilized to allow a user to interface with the processing machine or machines that are used to implement the embodiment. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, itis contemplated that the user interface might interact, e.g., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

While the embodiments have been particularly shown and described within the framework of financial services machines, such as EBKs and ATMs, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

1. A system, comprising:
a financial transaction machine, associated with a financial institution, comprising:
at least one non-transitory storage medium comprising computer readable instructions to conduct a cardless transaction, the cardless transaction comprising at least one of a cardless withdrawal and a cardless deposit, such that the computer readable instructions cause a display of an option to conduct the cardless transaction, cause a request for entry of a code to be displayed upon selection of the option to conduct the cardless transaction, cause a validation of an entered code to be performed, and cause the cardless transaction to occur upon validation of the entered code and wherein the cardless transaction is conducted for the purpose of a withdrawal or deposit, directly from or to an account associated with a customer, at the financial institution, for the benefit of the customer;
at least one display, the at least one display being configured to display the option to conduct the cardless transaction with the financial transaction machine, the at least one display being further configured to display a request for entry of the code upon the selection of the option to conduct the cardless transaction;
at least one input device, the at least one input device being configured to receive one or more inputs in response to the selection of the option to conduct the cardless transaction, the one or more inputs comprising at least entry of the code; and
at least one processor, communicatively coupled to a network, configured to cause validation of the received code, responsive to the instructions, and further configured to cause completion of the cardless transaction upon successful validation of the code; and
a remotely located server, associated with the financial institution and communicatively coupled to the network, that is configured to receive a validation request of the code from the at least one processor and to conduct a validation of the received code, and being further configured to transmit a result of the validation to the at least one processor wherein the code was previously generated by the remotely located server in response to a request from a mobile banking application to conduct the cardless transaction at the financial transaction machine and the code was transmitted to a mobile banking application.

2. (canceled)

3. The system of claim 1, the at least one processor being further configured to cancel the cardless transaction upon an unsuccessful validation of the code and being further configured to notify the mobile banking application of the unsuccessful validation of the code.

4. (canceled)

5. A method, comprising:
receiving, by a computer processor, a request for a cardless transaction comprising a withdrawal from a mobile banking application installed on a mobile device, wherein the request for the withdrawal comprises a withdrawal amount entered into the mobile banking application and the withdrawal comprises a direct withdrawal of funds from an account, at a financial institution, associated with a customer; and
receiving, by the computer processor, a code from the mobile banking application in response to the request, wherein the code was generated by the mobile banking application.

6. (canceled)

7. The method of claim 5, wherein the code is valid for a predetermined length of time.

8. The method of claim 7, wherein the predetermined length of time is determined by a user of the mobile banking application.

9. The method of claim 5, further comprising:
receiving a selection of a financial transaction machine at which the cardless transaction is to be conducted.

10. The method of claim 9, further comprising:
transmitting the request and the code for the cardless transaction to the selected financial transaction machine.

11. A method, comprising:
receiving, by a financial transaction machine, associated with a financial institution, a selection of a menu option at a display of the financial transaction machine, to conduct a cardless transaction, the cardless transaction comprising at least one of a cardless withdrawal and a cardless deposit, wherein the cardless transaction was previously requested through a mobile banking application and wherein the cardless transaction is conducted with for the purpose of a withdrawal or deposit, directly from or to an account associated with a customer at the financial institution;
requesting, by the financial transaction machine, entry of a code;
receiving, by the financial transaction machine, entry of the code;
verifying the code; and
performing, upon successful verification, by the financial transaction machine, the cardless transaction.

12. The method of claim 11, further comprising:
cancelling the cardless transaction upon unsuccessful verification.

13. The method of claim 11, further comprising:
requesting reentry of the code upon unsuccessful verification; and
cancelling the cardless transaction following a predetermined number of unsuccessful verifications.

14. The method of claim 11, further comprising:
requesting entry of identifying information in addition to the code;
receiving entry of the identifying information; and
verifying the received identifying information in addition to the code.

15. The method of claim 14, wherein the identifying information comprises at least one of a cell phone number and a personal identification number.

16. The method of claim 11, wherein step of the verifying is performed locally at the financial transaction machine.

17. The method of claim 11, wherein the step of verifying is performed remotely from the financial transaction machine.

18. The method of claim 11, further comprising:
receiving information pertaining to the cardless transaction and the code prior to the selection of the menu option to conduct the cardless transaction.

19. The method of claim 18, wherein the code is locally generated by the mobile banking application during the request for the cardless transaction.

20. The method of claim 18, wherein the code is remotely generated from the mobile banking application during the request for the cardless transaction.

21. A method, comprising:
receiving, by a computer processor, at a point of sale device, a selection to conduct a cardless transaction, wherein the cardless transaction was previously requested through a mobile banking application and the cardless transaction is for the purchase of goods or services from a merchant;
requesting, by the computer processor, entry of a code;
receiving, by the computer processor, entry of the code;
verifying the code; and
performing, upon successful verification, by the computer processor, the cardless transaction.

22. The method of claim 21, further comprising:
cancelling the cardless transaction upon unsuccessful verification.

23. The method of claim 21, further comprising:
requesting reentry of the code upon unsuccessful verification; and
cancelling the cardless transaction following a predetermined number of unsuccessful verifications.

24. The method of claim 21, further comprising:
requesting entry of identifying information in addition to the code;
receiving entry of the identifying information; and
verifying the received identifying information in addition to the code.

25. The method of claim 24, wherein the identifying information comprises at least one of a cell phone number and a personal identification number.

26. The method of claim 21, wherein the step of verifying is performed remotely from the point of sale device.

27. The method of claim 21, wherein the code comprises 16 digits and serves as a temporary credit card number.
